(19) United States
(12) Patent Application Publication
(10) Pub. No.: US 2023/0321902 A1
(43) Pub. Date: Oct. 12, 2023

(54) Modular 3D printer hardware Print Unit elements to enable a Production Network

(71) Applicant: INDUSTRY SUPPLIES, INC., Newark, DE (US)

(72) Inventor: Martin D. Fiumura, Buenos Aires (AR)

(21) Appl. No.: 18/297,028

(22) Filed: Apr. 7, 2023

Related U.S. Application Data
(60) Provisional application No. 63/328,560, filed on Apr. 7, 2022.

(51) Int. Cl. B29C 64/20; B29C 64/386; B29C 64/314; B29C 64/40; B29C 64/118; B33Y 30/00; B33Y 40/20; B33Y 40/10

(52) U.S. Cl. CPC B29C 64/20; B29C 64/386; B29C 64/314; B29C 64/40; B29C 64/118; B33Y 30/00; B33Y 40/20; B33Y 40/10

(57) ABSTRACT

Method, system, and apparatus for a Production Network used in Additive Manufacturing and, more particularly, a Single Print Unit and a Print Array using the same Print Unit Modules to enable a scalable Production Network with no downtime thanks to interchangeable modules and centralized control.

### FIELD OF THE INVENTION

This invention relates to a 3D additive manufacturing system's Array. The Print Array architecture is devised to support and manage scalable part production by deploying modular and interchangeable Print Unit modules.

### BACKGROUND OF THE INVENTION

Over the decades, additive manufacturing (AM) has matured into a reliable technology with a great variety of equipment and advanced software options. Faster machines, better materials, and smarter software are helping to make AM a realistic solution for many real-world production applications. As processes have matured and materials science has accelerated, additive manufacturing is now used throughout the full production cycle complementing traditional manufacturing processes.

AM technology is now proven, well-understood and established as a manufacturing method across many industry sectors. The key standards have been developed, enabling repeatable quality at scale. AM systems offer several benefits, including increased flexibility, independence, as well as time and cost savings.

Industrial 3D printing systems have been developed as complex technical equipment, which requires technical training to develop practical operation and maintenance skills. Taking into consideration the organization's need for early-stage adoption and scalability, the present invention aims at making more efficient operation, maintenance, technical services to 3D printing systems so to reduce downtime, and thus maintenance and training costs.

The main obstacle preventing the adoption of 3D printers into an industrial manufacturing process is the lack of a workflow from prototyping to scalable production. In fact, companies use 3D printers as stand-alone equipment in which they prototype and also manufacture the final parts they need in low volume batches. A target company may purchase a few units to cover the production needs by operating each unit individually.

On one side, the R&D team requires the agility to iterate prototypes and finalize the design for each component. On the other side, the procurement team has to develop the supply chain, and thus determine whether to convert the designs onto another manufacturing process (with great cost and lead time) or, if manufacturing with 3D printers is possible for that application, to purchase more 3D printers to meet the production needs. No 3D printer product line offers a real solution to solve both the needs of the R&D team and those of procurement.

Providing a path to an additive manufacturing Production Network requires hardware, electronics, control protocols and software. This patent covers the hardware.

### SUMMARY OF THE INVENTION

Process development is based on the system architecture of the 3D printer being used. The critical machine elements are the XY motion system, hotend, nozzle geometry, filament drive system, chamber heating, and filament drying. Related variables such as material type and size are determined by the machine requirements.

The current state-of-the-art Stratasys FDM systems are typical. For example, the F370 prototyping system is based on MakerBot technology, has limited materials, and is priced for departmental use at less than $50,000. Their industrial model Fortus 450MC is based on older Stratasys technology, has a more extensive range of materials and is priced $160,000-$220,000 depending on options.

The issue with the use of these machines is that they share very little in architecture, almost like different companies created them. An engineer creating functional prototypes on the F370 has to redo that development effort on the production machine to scale. These are all impediments to the creation of a true digital workflow.

The node-based 3D printing is a structural difference that requires a new control protocol and results in a network-based production: the Production Network.

Interoperability at this level enables not just distributed control of printers but distributed production.

The design of the motion module is used in both the Print Array (FIG. 1) and the Single Print Unit (FIG. 2) product lines. Print Units (FIG. 4) have been modularly designed to make them interchangeable for the Print Array Host (FIG. 9). The print module (1) is sized in order to be easily removed through the existing door of the Print Array Host (FIG. 9). The mounting system (FIG. 8) in the Print Array Host (FIG. 9) has also been especially designed for such purposes, as well as the electrical/mechanical/software interface between the module and the Print Array Host (FIG. 9) (covered on a separate patent IDF).

### BRIEF DESCRIPTION OF THE DRAWINGS

Further features and advantages of the invention will become apparent from the following detailed description taken in conjunction with the accompanying figures showing illustrative embodiments of the invention, in which:

FIG. 1 is a perspective view of a Print Array unit featuring one-to-one matchup of Electronics Module (2) to Print Unit (1) and Feeding and Drying Module (3) in accordance with the present invention.

FIG. 2 is a perspective view of a Single Print Unit for prototyping in accordance with the present invention.

FIG. 3 is a perspective view of a Print Unit Module inside a Single Print Unit (FIG. 2) without outer panels featuring an integrated Electronics Module (4) in accordance with the present invention.

FIG. 4 is a perspective view of a Print Unit Module of the Print Array (FIG. 1) featuring an electrical keying fast-locking connector at the end of the cabling bundle (5) in accordance with the present invention.

FIG. 5 is a perspective view of a Feeding System up to the extruders in the Print Unit (6) featuring electronics (7), a Drying Module (8), and 2 Buffers (9), in accordance with the present invention.

FIGS. 6a and 6b are perspective views of the Electronics Module cabinet in accordance with the present invention.

FIG. 7a is a perspective view of a Print Unit's components including the XY motion system (15), filament drive system, chamber heating system (14), Z motion system (11), air-flow system (12), and insulation (10).

FIG. 7b is a front view of a Print Unit's components including the XY motion system (15), hotends (16), nozzle geometry (16), filament drive system, chamber heating system (14), build platform (13), and air-flow system (12), in accordance with the present invention.

FIG. 8 is a perspective view of a Print Unit next to its associated Electronics Module on the Print Array structure in accordance with the present invention.

FIG. 9 is a perspective view of Print Array Host showing a Print Unit (19), an Electronics Module (17), and a Feeding and Drying Module (18) sliding in, in accordance with the present invention.

FIG. 10 is a perspective view of a Print Unit showing the four keying elements (20) designed to fit and slide into T-slotted aluminum profiles in accordance with the present invention.

FIG. 11. is a front view of a Print Unit adjacent to an Electronics Module featuring keying elements (22) fitting into the T-slotted aluminum profiles on the Print Array structure and a display (21), in accordance with the present invention.

FIG. 12 is a perspective view of blocking clamps on the Print Array T-slotted aluminum profiles securing the Print Unit to the Print Array Host interface in accordance with the present invention.

FIG. 13 is a perspective view of a Print Array Host featuring a switch (23), an internal Router (24), and a CPU (25) in accordance with the present invention.

### DETAILED DESCRIPTION OF THE INVENTION

### Definitions

| | |
|---|---|
| PU or Print Unit | Print Unit or the modular 3D printing module. |
| | Also, a measure of production capacity (e.g. |
| | a Prototyping Unit = 1 PU; a Production |
| | Machine = 4 PUs) |
| SPU or Single Print Unit | Prototyping Unit |
| PA or Print Array | Production Machine or PM |
| PAH or Print Array Host | Empty Production Machine, no PUs or EMs |
| EM | Electronics Module |
| PN | Production Network or network that these |
| | various print capabilities use for |
| | communications and control |
| Node | A generic print node connected a Prototyping |
| | Unit or Production Machine attached to a |
| | Production Network |
| DRM | Digital Rights Management |
| Control CPU | Central non-real-time controller that manages |
| | a PA. SPUs do not have a Control CPU. |

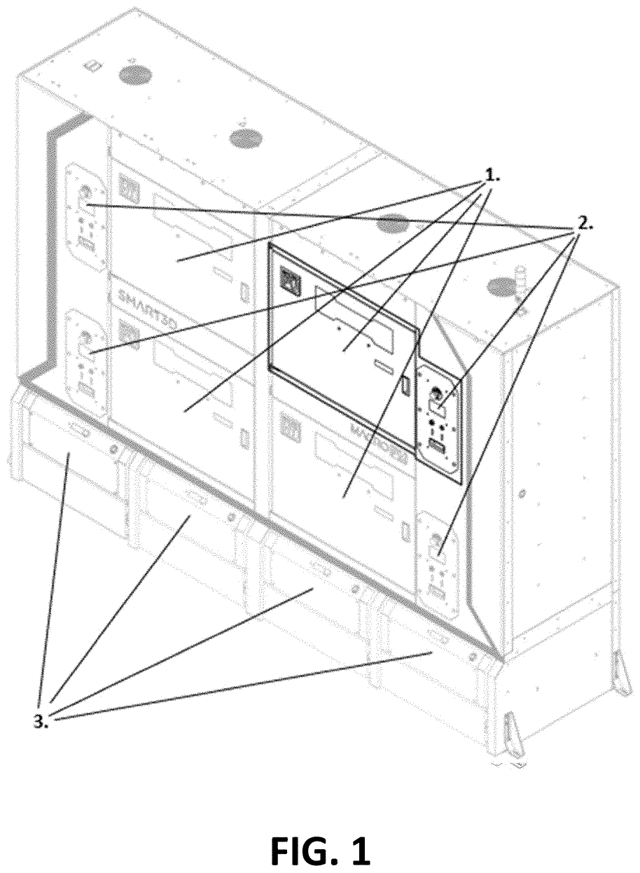

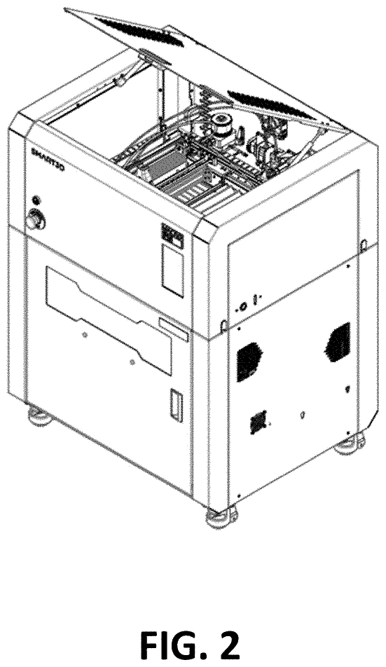

The systems of the present invention were designed for different users, spaces and applications for additive manufacturing. The Single Print Unit (FIG. 2) (SPU) is a prototyping machine to be used by a designer or engineer at an office to rapidly iterate on the different stages of product development. The Print Array (FIG. 1) (Production Machine), on the other hand, is a production machine meant for the manufacturing of tools, fixtures and end-use parts, among others, typically on the factory floor.

These users and setups have different needs. While a designer at an office may see material drying, print queuing, on-screen slicing, automatic material backup and others as “nice-to-have” features, for a production engineer running a batch of hundreds or thousands of parts at a factory they significantly lower labor, downtime, and risk of failure.

For prototyping and first adoption, Single Print Unit (FIG. 2) is a self-standing equipment. The Print Array (FIG. 1) system is a fundamental structure populated with interchangeable modules. In the present invention, Production Machines (PM) are Print Array (FIG. 1) systems in 2×2 or larger arrays of Print Units (PU) (1), to provide consistent, scalable motion and print control.

The novelty of the present patent is the modular structure of the Print Unit (1) and Print Array (FIG. 1) product line. The new technical modular system of the present invention enables a Production Network using a unique hardware architecture. The Print Array (FIG. 1) system is a fundamental structure populated with modules. The modular architecture gives redundancy to the Production Machine (FIG. 1) in case of failure of one or more modules.

In the preferred embodiment of the present invention, Fused Filament Fabrication (FFF) is the 3D printing technology deployed. In another embodiment, interchangeable modules can include all types of additive manufacturing equipment, as well as traditional manufacturing, inspection and scanning technologies.

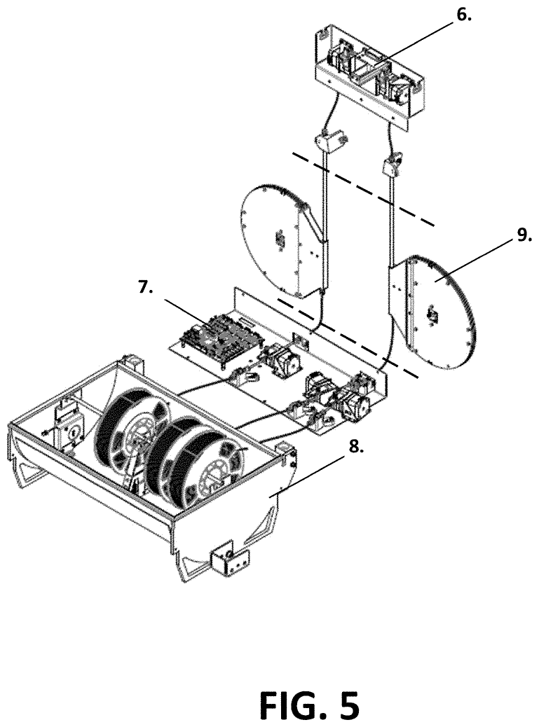

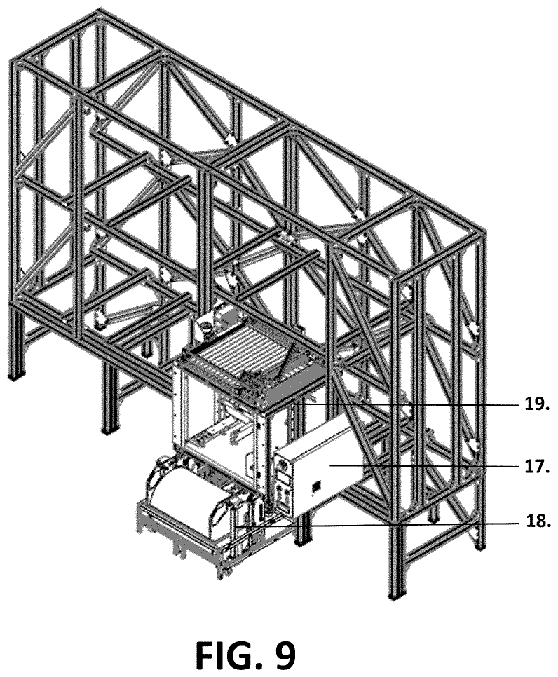

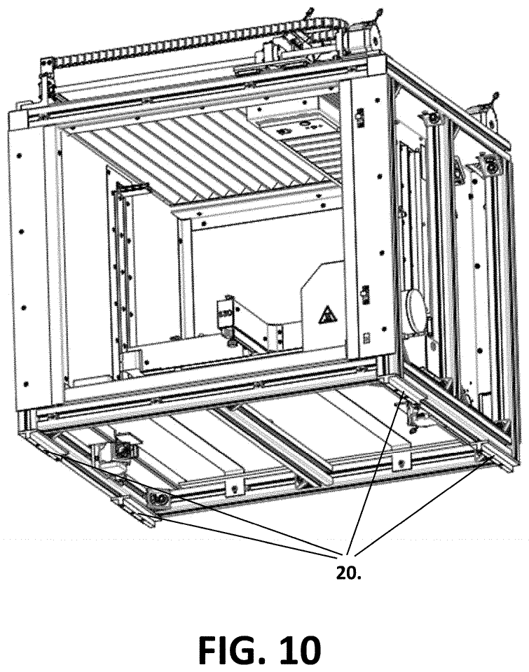

Production Machines (FIG. 1) consist of a sturdy aluminum framing structure (FIG. 9), which contains 2×2 modular sets. These sets are composed by 1 Print Unit module (1), 1 Electronics Module (2), and 1 feeding system with a buffer (3)(FIG. 9). In an embodiment of the present invention, the Production Machine (FIG. 1) includes material feeding and drying systems (FIG. 5) and a CPU (22). In another embodiment of the present invention, according to the technology deployed, the Production Machine (FIG. 1) can support other ancillary equipment modules, such as annealing systems, vacuum systems, ultrasonic resin cleaner, support removal systems.

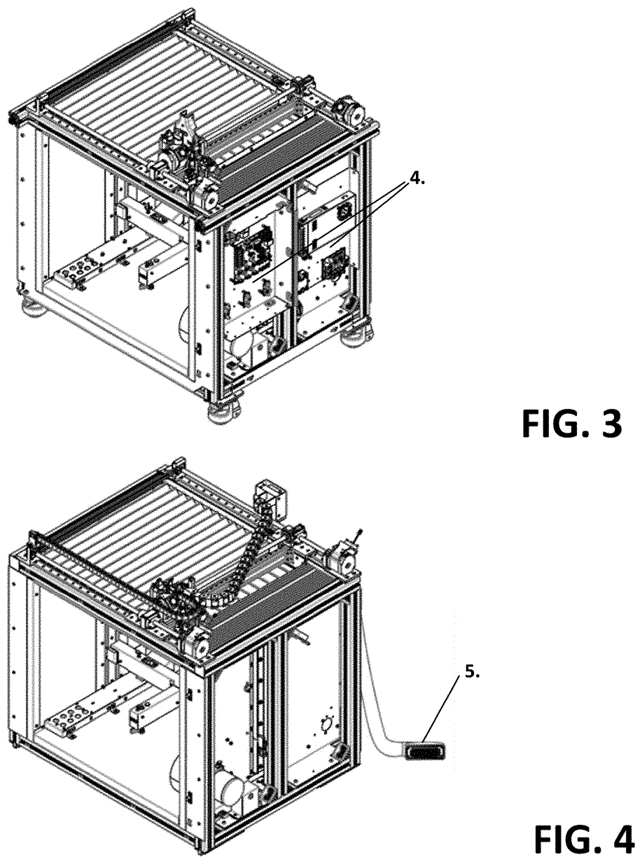

The design of the motion module is used both in the Single Print Unit (FIG. 2) model used for prototyping and in the Print Array (FIG. 1) product line. Single Print Units (FIG. 2) share the same motion configuration with each Print Unit within the Production Machine (FIG. 3 and FIG. 4). These motion module (FIG. 4) elements in the Print Array (FIG. 1) are modular and interchangeable.

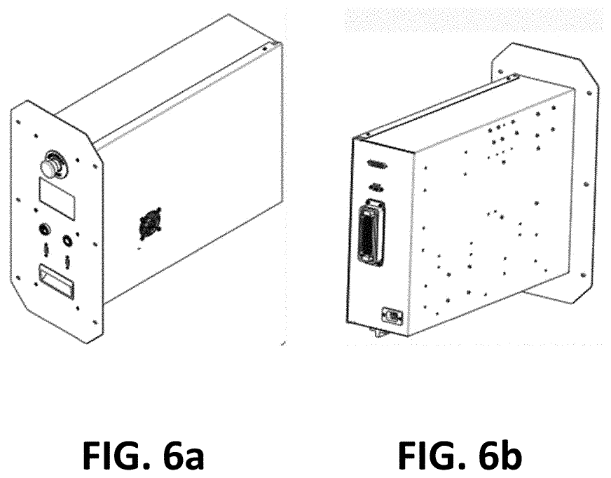

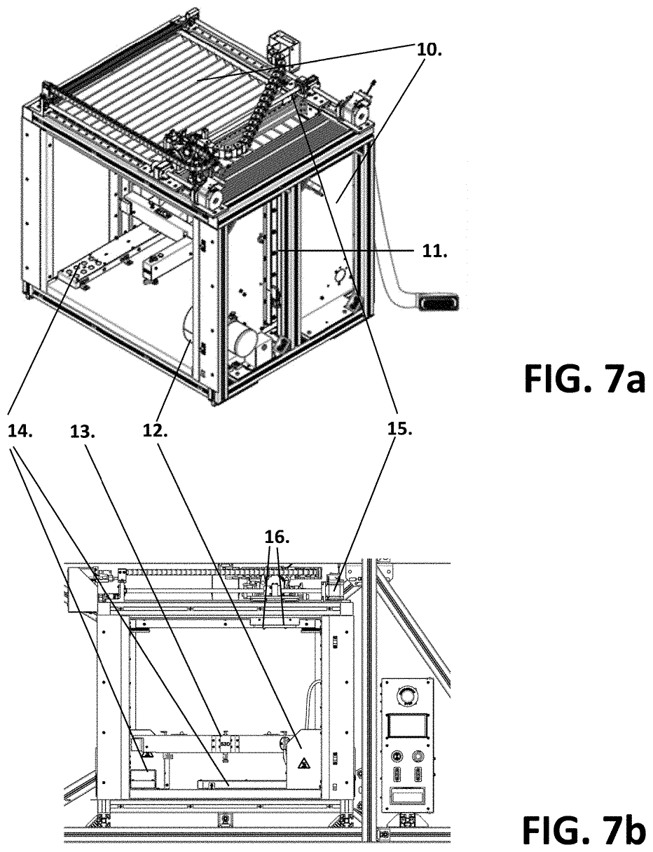

Each Print Unit (1) has an Electronics Module (2) associated with it, both in prototyping Single Print Units (FIG. 4) and in production Print Arrays (FIG. 1). Electronics Modules (FIG. 6a, FIG. 6b) elements can support Print Unit's (1) different configurations across the prototyping and the production product lines. And identically to the Electronics Modules, Print Units are removable for higher uptime in production setups (1, FIG. 4) but non-removable in the prototyping line (FIG. 3).

The Print Unit (FIG. 4) element consists of a sturdy aluminum framing structure containing the whole motion system and 3D printing elements of a Single Print Unit (FIG. 2, FIG. 3). This includes, among others, the XY motion system (15), hotends (16), nozzle geometry (16), filament drive system (6), chamber heating system (14), build platform (13), Z motion system (11), air-flow system (12), and insulation (10).

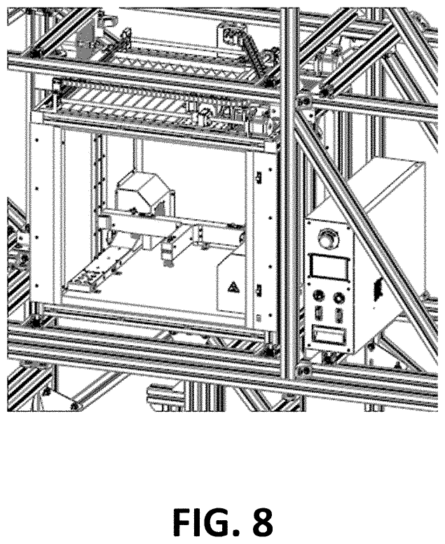

Each Print Unit (FIG. 4) in the Print Array (FIG. 1) can feature different characteristics in any combination, such as extrusion and chamber temperature, or single or dual extrusion for printing a greater variety of engineering or high-performance polymers. Each Print Unit (1) in the Print Array (FIG. 1) has an Electronics Module (2) arranged next to the individual Print Unit (FIG. 8), which supports any combination of such characteristics.

For instance, insulation (16) is a part of the module, not the Print Array Host, so that modules with high temperature capabilities can be mixed in arrayed systems. It can also include, among others, direct or Bowden (6) extrusion system, any relevant sensor, and fiber, liquid or gas, or any other kind of material application system.

Single Print Units (FIG. 2) are tools for designers and engineers working on different phases in the product life-cycle, such as product development, design iterations, material testing and validation, development and production of manufacturing aids, and spare parts, among others. They enable the creation of a digital inventory, which is the source used at the factory to efficiently select, automate and scale a production process within common material sets and configurations.

Single Print Units (FIG. 2) are low-cost devices which accelerate the production of each iteration of a prototype, avoid the need for outsourcing with their external quoting requirements and supply chain bottlenecks, reduce lead times, and make every part they process ready for internal production and scale.

Single Print Units (FIG. 2) may be a simplified version of the Print Units present in Production Machines (FIG. 1). Their core architecture shall not differ, as material compatibility, precision, and speed need to be identical for the transparent transition between prototyping and production. But ancillary features such as material drying, automatic feeding, material backup, Print Unit management or the facilitated replacement of Print Units (FIG. 4) or Electronics Modules (FIG. 6) are not required, favoring lower capital investments in the product validation phases of the product lifecycle. The motion system in Single Print Units (FIG. 3), unlike Print Units in Production Modules, is not removable for rapid replacement since this feature is only a requirement to improve production uptime.

The Print Unit (FIG. 4) module presents a compact XYZ (10, 14) motion system fitting within the frame of the motion unit. The Print Unit (FIG. 4) element has been sized to be easily removed through the existing 2×2 doors of the Print Array Host (FIG. 8). In fact, modular Print Unit (FIG. 4) elements are loaded through the same door (1) at printing access. Serviceability is improved by including all wear and consumables items in the module.

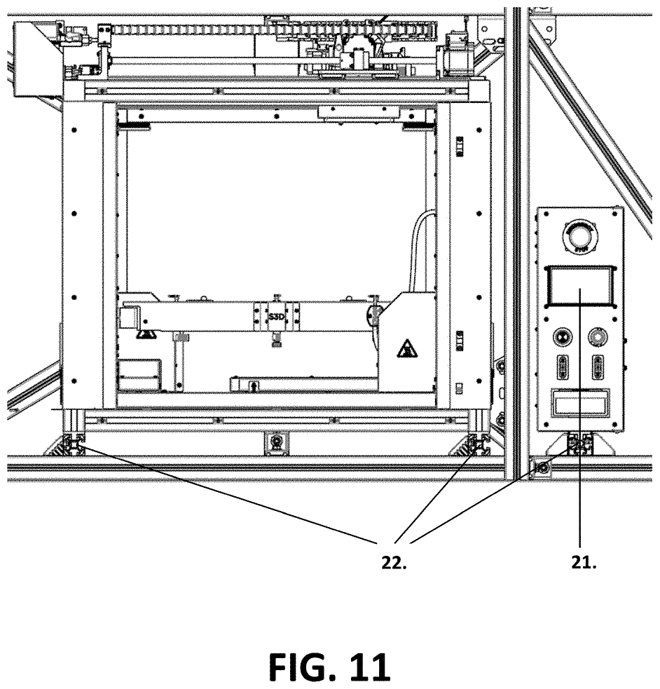

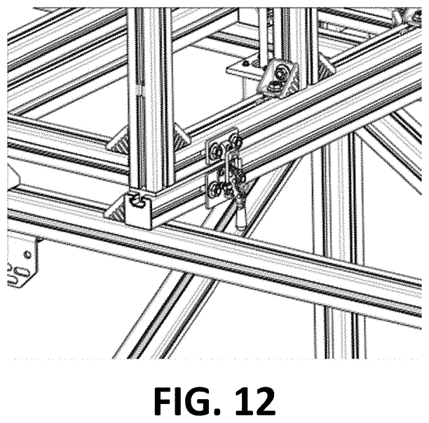

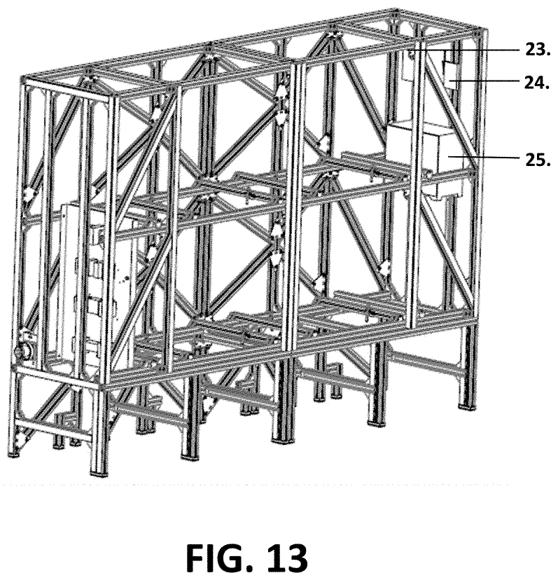

Each Print Unit module is equipped with a sliding mounting system with blocking clamps on the Print Array Host (FIG. 9). In the preferred embodiment of the present invention, the sliding mounting system consists of keying elements (20) which fit into the T-slotted aluminum profiles (21), allowing modules to slide or roll in and out with ease (FIG. 9). Blocking clamps (FIG. 11) can include screw clamps, spring clamps, strap clamps, bench clamps, or any other means to secure each unit to the Print Array structure for security purposes.

The Print Units' sliding mounting systems allow PUs to be easily swapped within minutes. This reduces production downtime by rapidly replacing a unit needing maintenance with another one ready for service.

In the preferred embodiment of the present invention, each Print Unit operates in conjunction with a dedicated material Feeding System (FIG. 5) located at the bottom of the Print Array structure. Each Feeding System also supports a material Drying System (18). The material Drying System maintains polymers at controlled conditions, such as moisture content or temperature. The material Drying System (FIG. 5) includes a great variety of sensors and functions, such as material backup, filament-runout sensor, active moisture control, and other sensors for monitoring, reporting and statistics.

Each Feeding and Drying System (8) pushes the material up to a dedicated Buffer (9) in the Print Array Host. The Buffer system handles the material feeding distance between the spools in each Feeding and Drying System and the print head in each Print Unit (6). In the preferred embodiment of this invention, the Buffer is mechanical.

The present invention has a constant, defined quick-change interface at the Electronics Module to the Production Machine and a separate quick-change defined interface from the Print Array to the Print Unit.

The Print Unit module connects to an Electronics Module thanks to a keying element. In the preferred embodiment of the present invention, the keying element is an industrial 108-pin heavy duty connector for plug sockets (5). Each Print Unit, Electronics Module, and Feeding and Drying System are interchangeable and can be easily removed individually. This modular architecture allows fast removal with almost no production downtime.

For industrial production environments, multiple systems have a modular architecture arranged in 2×2 (FIG. 1) or larger arrays linearly for manual material loading and unloading. In another embodiment, multiple systems have a modular architecture arranged in 2×2 or larger arrays in a semicircle for efficient robotic loading and unloading.

In an embodiment of the present invention, each Print Unit can be manually operated directly from the Electronics Module's display (22). Print Units may also be connected to a tower light and an acoustic indicator to alert the operator upon security or operation warnings.

In another embodiment, each Production Machine comes with a dedicated computer (CPU) (25) that executes control commands. In the preferred embodiment of the present invention, the CPU (25) can control all modules in the Print Array in one interface. Through the CPU (25), the operator can access the Print Units, Feeding and Drying Modules' command console to execute G-code commands. The CPU (25) is also capable of processing slicing for all its 2×2 printing chambers, in addition to multiple monitoring and control features.

The CPU (25) can be equipped with a display, a keyboard, and a mouse or touchpad. In the preferred embodiment of the present invention, the CPU (25) connects via Ethernet to both Electronics Modules and Drying and Feeding Systems to show their status in one centralized interface. In another embodiment, CPU (25) may include a touch display or a removable tablet with a connection feature to the Production Machine (FIG. 1). In the mentioned embodiment, the operator can remove the display to work on it in front of the chamber he/she is operating, for maintenance or technical support.

In the preferred embodiment of the present invention, the Production Machine has a built-in Router (24). The Internal Router (24) connects to Electronics Modules (2), and material Feeding and Drying Systems board (7) in the Print Array.

The Internal Router (24) can be configured to connect to an external NAT server, router, or switch. The Production Machine Router (24) supports either static or dynamic IP address configurations for each module.

Each Electronics Module (2) comprises a Single Board Computer (SBC) with a dedicated SD card in which it stores all the Print Unit's offset and calibration values. Machine performance offsets are interpreted in the Electronics Module (2) to provide consistent printing performance for each Print Unit (1). The Production Machine (FIG. 1) is connected to the user's network via LAN, Ethernet, or Wi-Fi, according to local security requirements.

Once connected, all modules in the Print Array Host (FIG. 9) can be operated and visualized via remote connection via IP or local host. Each module self-identifies on this Production Network as an individual addressable and controllable print node. Thanks to the logical interface handshake protocol, this node-based 3D printing creates a new control protocol and sets the foundations for a network-based production, based on a true digital workflow.

The Electronics Module sets global address and type for network, and reads nozzle size for the Print Unit (FIG. 4), material type from the Material Feeding System (FIG. 5), and Print Unit's performance offsets. The common logical interface enforced this way also opens up generic APIs to address and control network printers. When a Print Unit (1) requires maintenance, the module is removed from the Print Array (FIG. 1) together with its dedicated SD card containing its offset and calibration data.

Close matching of module performance also allows remote process development for material parameters, printing, and optimization. This feature enables the module's performance for required materials and applications to be optimized outside the production floor, either by the company's R&D teams or by external process engineers on the Single Print Unit (FIG. 2) used for Prototyping.

Once the process has been optimized, no transition is required from the prototype build with the Single Print Unit (FIG. 2) to the Production Machine (FIG. 1) for scaling up manufacturing. The modular architecture allows economies of scale, by reducing the cost of both production and prototyping modules. This eliminates the gap to adopt and scale up additive manufacturing in high-volume industrial environments, as factories can simply add Production Arrays (FIG. 1) with their Print Units (1) to rapidly meet their growing production demand.

The foregoing describes the preferred embodiment of the invention and sets forth the best mode contemplated for carrying out the invention in such terms as to facilitate the practice of the invention by a person of ordinary skill in the art. However, it is to be understood that the invention has many aspects, is not limited to the structure, processes, methods, and embodiment disclosed and/or claimed, and that equivalents to the disclosed structure, processes, methods, embodiment, and claims are within the scope of the invention as defined by the claims appended hereto or added subsequently.

Although the present invention has been described herein with reference to the foregoing exemplary embodiment, this embodiment does not serve to limit the scope of the present invention. Accordingly, those skilled in the art to which the present invention pertains will appreciate that various modifications and equivalents are possible, without departing from the technical spirit of the present invention.

1. An industrial 3D printing device enabling a scalable Production Network having:
a unique architecture shared with both Single Print Units for prototyping and Print Arrays for production;
modular Print Unit elements which are mechanically and electronically the same in Single Print Units for prototyping as in Print Arrays for production.

2. The apparatus according to claim 1, wherein each Print Unit works in conjunction with an Electronics Module with a static memory device both in Single Print Units and in Print Arrays.

3. The apparatus according to claim 1, wherein each Print Unit in Print Arrays is arranged in 2×2 or larger arrays:
either linearly for manual loading and unloading;
or in a semicircle for robotic loading and unloading.

4. The apparatus according to claim 1, wherein said Print Unit in Single Print Units for prototyping and Print Arrays for production contains the same components comprising:
XY motion system;
hotends;
nozzles;
filament drive system;
chamber heating system;
build platform;
Z motion system;
air-flow system;
air-filtration system;
insulation;
hotend cooling system;
sensors;
all consumable and wear items.

5. The apparatus according to claim 1, wherein said Print Unit module on Single Print Units has an integrated architecture and is not removable.

6. The apparatus according to claim 1, wherein said Print Array may house 2×2 modules of:
Print Units for engineering materials;
Print Units for high-performance materials;
material feeding systems;
material drying systems;
annealing systems;
vacuum systems;
ultrasonic resin cleaners;
support-material removal systems;
dying, sanding and/or painting systems;
post-processing automation equipment.

7. The method wherein said Print Unit module has a constant, defined quick-change interface from the Print Unit to the Print Array Host and a separate quick-change defined interface from the Print Array Host to the Electronics Module, comprising:
keying elements;
a slide-in mounting system;
blocking clamps.

8. The method according to claim 7, wherein said Print Unit is a slide-out interchangeable subassembly.

9. The method according to claim 7, wherein said Print Unit can be removed individually for technical service.

10. The method according to claim 7, wherein said Print Unit self-identifies on the Production Network as an individual addressable and controllable print node.

11. The method according to claim 7, wherein said Print Unit's Electronics Module stores machine performance offsets only of its associated Print Unit.

12. The method wherein process development for material parameters, printing, and optimization is made remotely thanks to identical module performance of Single Print Units and Print Units in Print Arrays.
